(19) United States
(12) Patent Application Publication
(10) Pub. No.: US 2014/0341621 A1
(43) Pub. Date: Nov. 20, 2014

(54) IMAGE FIXING DEVICE AND IMAGE FORMING APPARATUS

(71) Applicant: FUJI XEROX CO., LTD., Tokyo (JP)

(72) Inventors: Kenji OMORI, Kanagawa (JP); Yasuto OKABAYASHI, Kanagawa (JP); Satoshi MIZOGUCHI, Kanagawa (JP)

(73) Assignee: FUJI XEROX CO., LTD., Tokyo (JP)

(21) Appl. No.: 14/109,307

(22) Filed: Dec. 17, 2013

(30) Foreign Application Priority Data
May 14, 2013 (JP) 2013-102551

(51) Int. Cl. G03G 15/20

(52) U.S. Cl. CPC G03G 15/2025
USPC 399/329

(57) ABSTRACT

An image fixing device includes a first rotating body, a second rotating body, a pressing member, a sheet member, and a lubricant. The second rotating body is disposed in contact with an outer surface of the first rotating body. The pressing member is disposed within the second rotating body and presses the second rotating body toward the first rotating body from an inner surface of the second rotating body. The sheet member is disposed between the second rotating body and the pressing member and has a slide layer containing cross-linked polytetrafluoroethylene resin. The lubricant is interposed between the second rotating body and the sheet member and contains amino-modified silicone oil and terminal-modified perfluoropolyether.

### CROSS-REFERENCE TO RELATED APPLICATIONS

This application is based on and claims priority under 35 USC 119 from Japanese Patent Application No. 2013-102551 filed May 14, 2013.

### BACKGROUND

### Technical Field

The present invention relates to image fixing devices and image forming apparatuses.

### SUMMARY

According to an aspect of the invention, there is provided an image fixing device including a first rotating body, a second rotating body, a pressing member, a sheet member, and a lubricant. The second rotating body is disposed in contact with an outer surface of the first rotating body. The pressing member is disposed within the second rotating body and presses the second rotating body toward the first rotating body from an inner surface of the second rotating body. The sheet member is disposed between the second rotating body and the pressing member and has a slide layer containing cross-linked polytetrafluoroethylene resin. The lubricant is interposed between the second rotating body and the sheet member and contains amino-modified silicone oil and terminal-modified perfluoropolyether.

### BRIEF DESCRIPTION OF THE DRAWINGS

Exemplary embodiments of the present invention will be described in detail based on the following figures, wherein:

FIG. 1 schematically illustrates the configuration of an image fixing device according to a first exemplary embodiment;

FIG. 2 schematically illustrates the configuration of an image fixing device according to a second exemplary embodiment; and

FIG. 3 schematically illustrates a configuration example of an image forming apparatus according to an exemplary embodiment.

### DETAILED DESCRIPTION

Exemplary embodiments of the present invention will be described below. The following description and examples are merely examples of the present invention and are not intended to limit the scope of the exemplary embodiments of the present invention.

An image fixing device (also referred to as “fixing device” hereinafter) according to an exemplary embodiment includes a first rotating body, a second rotating body disposed in contact with an outer surface of the first rotating body, a pressing member that is disposed within the second rotating body and presses the second rotating body toward the first rotating body from an inner surface of the second rotating body, a sheet member disposed between the second rotating body and the pressing member, and a lubricant interposed between the second rotating body and the sheet member.

In the sheet member, a slide layer thereof that constitutes a surface on which the second rotating body slides contains cross-linked polytetrafluoroethylene resin (also referred to as “cross-linked PTFE resin” hereinafter). The lubricant contains amino-modified silicone oil and terminal-modified perfluoropolyether (also referred to as “terminal-modified PFPE” hereinafter).

The fixing device according to this exemplary embodiment has the above-described configuration so that the occurrence of an increase in drive torque caused by repeated image fixing processes may be reduced. The reason for this is uncertain, but is assumed as follows.

In the related art, polytetrafluoroethylene resin (PTFE resin) is used as an example of resin constituting the slide surface of the sheet member.

Among various kinds of PTFE resin, since cross-linked PTFE resin has a net-like cross-linked structure, polymer molecules are less likely to move when the sheet member receives stress, as compared with non-cross-linked PTFE resin. Therefore, with the slide surface of the sheet member containing cross-linked PTFE resin, the mechanical strength of the sheet member increases.

Known examples of suitable lubricant include dimethylpolysiloxane (dimethyl silicone oil) and a derivative thereof (modified silicone oil).

As compared with dimethyl silicone oil, amino-modified silicone oil, which is a kind of modified silicone oil, conceivably has excellent compatibility with polymer molecules contained in the sheet member due to an intermolecular force of an amino group incorporated within the molecules.

In addition, in a case where the polymer molecules contained in the sheet member are cross-linked PTFE, since the fluorine atoms in the cross-linked PTFE have negatively charged properties, amino-modified silicone oil having a positively charged amino group conceivably has excellent compatibility with cross-linked PTFE, as compared with dimethyl silicone oil or modified silicone oil having negatively charged properties or having a substituent group that is difficult to charge.

Terminal-modified PFPE has a fluorine atom at the side chain of its principle framework and thus has high compatibility with amino-modified silicone oil. On the other hand, with a substituent group incorporated into the terminal of the principle framework, terminal-modified PFPE conceivably has excellent compatibility with the polymer molecules contained in the sheet member due to an intermolecular force of this substituent group.

Therefore, terminal-modified PFPE conceivably allows for improved compatibility between amino-modified silicone oil and the sheet member.

With a synergistic effect of cross-linked PTFE resin, amino-modified silicone oil, and terminal-modified PFPE mentioned above, it is conceivable that the following effects are exhibited.

The cross-linked structure of cross-linked PTFE may conceivably increase the mechanical strength of the sheet member. In addition, amino-modified silicone oil and terminal-modified PFPE within the cross-linked structure may conceivably increase the elasticity and flexibility of the sheet member.

Furthermore, with good compatibility between cross-linked PTFE and amino-modified silicone oil as well as between cross-linked PTFE and terminal-modified PFPE, it is conceivable that the lubricant may efficiently exhibit its lubrication effect, and the abrasion resistance of the sheet member may be improved.

Therefore, the sheet member according to this exemplary embodiment may be resistant to abrasion and mechanical deformation caused by repeated image fixing processes. As a result, the fixing device according to this exemplary embodiment may conceivably reduce the occurrence of an increase in drive torque caused by repeated image fixing processes.

The following description relates to the sheet member and the lubricant included in the fixing device according to this exemplary embodiment.

Sheet Member

In addition to the slide layer that constitutes the surface (i.e., slide surface) on which the second rotating body slides, the sheet member according to this exemplary embodiment may also have another layer.

Specifically, the sheet member according to this exemplary embodiment may have, for example, a single-layer configuration formed of a slide layer alone, a double-layer configuration constituted of a substrate and a slide layer laminated over one surface thereof, or a triple-layer configuration constituted of a substrate, a slide layer laminated over one surface of the substrate, and a resin layer laminated over the other surface of the substrate.

Slide Layer

The slide layer constitutes the slide surface on which the second rotating body slides, and contains cross-linked PTFE resin. The slide layer may further contain, for example, another kind of resin or a filler.

The cross-linked PTFE may be, for example, cross-linked PTFE obtained by irradiating non-cross-linked PTFE with ionizing radiation. In detail, cross-linked PTFE is obtained by, for example, irradiating non-cross-linked PTFE, which is heated to a temperature higher than a crystalline melting point, with ionizing radiation (e.g., a γ ray, an electron beam, an x ray, a neutron ray, or high-energy ions) with a radiation dose ranging between 1 KGy and 10 MGy in a non-oxygen-existing environment.

PTFE may contain a copolymer component other than tetrafluoroethylene, such as perfluoro (alkyl vinyl ether), hexafluoropropylene, (perfluoro alkyl)ethylene, or chlorotrifluoroethylene.

Another kind of resin may be fluororesin. Specific examples include non-cross-linked PTFE resin, perfluoroalkoxy alkane, and an ethylene-tetrafluoroethylene copolymer. One of these fluororesin materials may be used, or two or more of these fluororesin materials may be used.

In view of the mechanical strength of the slide layer, the percentage of cross-linked PTFE resin relative to the overall amount of resin contained in the slide layer may be 5 percent by mass or higher, more desirably be 10 percent by mass or higher, more desirably be 15 percent by mass or higher, and even more desirably be 20 percent by mass or higher. On the other hand, in view of the processability of the slide layer, the aforementioned percentage may be 75 percent by mass or lower, more desirably be 70 percent by mass or lower, more desirably be 65 percent by mass or lower, and even more desirably be 60 percent by mass or lower.

The filler is an additive material for adding electrical conductivity, for enhancing durability, and so on.

Examples of filler used include a lubrication filler having a layer structure (e.g., molybdenum disulfide, hexagonal boron nitride, mica, graphite, tungsten disulfide, or talc), an electrically conductive filler (e.g., carbon black or graphite), and a filler containing heat resistant resin (e.g., imide-based resin, amide-based resin, or aromatic-polyester-based resin).

The filler used may be a single kind of filler or two or more kinds of fillers.

The amount of filler added may range between 1 part by mass and 30 parts by mass relative to 100 parts by mass of resin.

The thickness of the slide layer may be set in accordance with the existence and the properties of the substrate. In a case where the sheet member is constituted of a slide layer alone, the thickness of the slide layer may range between, for example, 100 μm and 500 μm. In a case where the sheet member additionally includes a substrate, the thickness of the slide layer may range between, for example, 10 μm and 100 μm.

Substrate

The substrate is sheet-shaped. Examples of substrate used include woven or nonwoven fabric formed of glass fiber or resin fiber and a resin sheet formed by using resin.

Examples of resin used include polyimide resin, polyamide resin, polyamide-imide resin, polyether-ester resin, polyarylate resin, polyester resin, and polyester resin with a reinforcement material as an additive.

The substrate may include a filler for adding electrical conductivity thereto, for enhancing the durability thereof, and so on.

The substrate may have a thickness ranging between, for example, 50 μm and 150 μm.

Another Resin Layer

A resin layer may be laminated over the opposite surface of the substrate from the surface thereof over which the slide layer is laminated.

The resin used for forming this resin layer may be fluororesin. Specific examples include non-cross-linked PTFE, cross-linked PTFE, perfluoroalkoxy alkane, and an ethylene-tetrafluoroethylene copolymer.

The thickness of this resin layer may range between, for example, 10 μm and 50 μm.

Method for Manufacturing Sheet Member

An example of a method for manufacturing the sheet member will now be described. Although the example described below is directed to the configuration in which the substrate and the slide layer are laminated, the exemplary embodiment is not limited to this configuration.

First, molding powder containing cross-linked PTFE resin is set in a mold and is compression-molded. Then, the molding power is heated and fired at a temperature higher than or equal to the melting point of the resin, whereby a molded body is obtained. This molded body is skived by using a metallic cutter, whereby a sheet material containing cross-linked PTFE resin is obtained.

Subsequently, a sheet for the substrate is prepared.

For example, commercially-available glass fiber fabric may be prepared, or a resin sheet made from molding powder may be formed.

Then, the sheet material containing cross-linked PTFE resin and the substrate are bonded to each other.

Examples of the bonding method include a method that involves coating the substrate with an adhesive, layering the sheet material containing cross-linked PTFE resin over the adhesive layer, and pressure-bonding the substrate, the adhesive layer, and the sheet material to each other; a method that involves layering the substrate and the sheet material containing cross-linked PTFE resin, and fusion-bonding the substrate and the sheet material to each other by heating them to a temperature higher than or equal to the melting point of the resin; and a method that involves impregnating the substrate formed of woven or nonwoven fabric with thermoplastic resin (e.g., fluororesin with low molecular weight), and heat-bonding the substrate and the sheet material containing cross-linked PTFE by using the thermoplastic resin as an adhesive.

Lubricant

The lubricant contains amino-modified silicone oil and terminal-modified PFPE, and may also contain another component (e.g., a known antioxidant or thickening agent).

Amino-modified silicone oil is a dimethylpolysiloxane derivative in which an amino group is incorporated within a dimethylpolysiloxane molecule.

The amino-modified silicone oil used may be, for example, a compound in which a substituent group, such as a 2-aminoethyl group, a 3-aminopropyl group, an N-cyclohexyl-3-aminopropyl group, or an N-(2-aminoethyl)-3-aminopropyl group, is bonded to a silicon atom within a dimethylpolysiloxane molecule. Specific examples include KF-8009A, KF-8009B, and KF8009C manufactured by Shin-Etsu Chemical Co., Ltd.

The kinetic viscosity (at 25° C.) of amino-modified silicone oil ranges between 100 mm²/s and 600 mm²/s.

The amino-modified silicone oil used may be a single kind of amino-modified silicone oil or a mixture of two or more kinds of amino-modified silicone oil.

The lubricant may contain silicone oil other than amino-modified silicone oil (e.g., dimethyl silicone oil or modified silicone oil other than amino-modified silicone oil).

However, the amino-modified silicone oil may occupy 80% by mass or higher of the overall silicone oil, more desirably occupy 90% by mass or higher of the overall silicone oil, and even more desirably occupy 100% by mass or higher of the overall silicone oil.

Terminal-modified PFPE is a perfluoropolyether derivative in which a substituent group is incorporated into one terminal or each terminal of perfluoropolyether (PFPE). The substituent group may be, for example, a phosphate group, a hydroxy group, a carboxyl group, or an amino group.

The substituent group may be incorporated into only one terminal of PFPE or into each terminal of PFPE.

Examples of terminal-modified PFPE used include a PFPE derivative having a phosphate group at a terminal thereof (referred to as “terminal-phosphate-modified PFPE”), a PFPE derivative having a hydroxy group at a terminal thereof (referred to as “terminal-alcohol-modified PFPE”), a PFPE derivative having a carboxyl group at a terminal thereof (referred to as “terminal-carboxylic-acid-modified PFPE”), and a PFPE derivative having an amino group at a terminal thereof (referred to as “terminal-amino-modified PFPE”).

In view of compatibility with cross-linked PTFE resin and amino-modified silicone oil, the terminal-modified PFPE used may be terminal-phosphate-modified PFPE, terminal-alcohol-modified PFPE, or terminal-carboxylic-acid-modified PFPE, more desirably be terminal-phosphate-modified PFPE or terminal-alcohol-modified PFPE, and even more desirably be terminal-phosphate-modified PFPE.

The weight-average molecular weight of terminal-modified PFPE may range between 2000 and 5000, and more desirably range between 3000 and 4000. With the weight-average molecular weight being larger than or equal to 2000, the occurrence of vaporization at high temperature is reduced. On the other hand, with the weight-average molecular weight being smaller than or equal to 5000, the terminal-modified PFPE may readily exist within the cross-linked structure of cross-linked PTFE.

In view of further suppressing an increase in drive torque caused by repeated image fixing processes, the amount of terminal-modified PFPE contained in the lubricant may be 0.05% by mass or higher, more desirably be 0.1 by mass or higher, and even more desirably be 0.5% by mass or higher. On the other hand, in view of the viscosity stability of the lubricant, the amount of terminal-modified PFPE contained in the lubricant may be 5% by mass or lower, more desirably be 4% by mass or lower, and even more desirably be 3% by mass or lower.

Fixing Device

The fixing device according to this exemplary embodiment includes the first rotating body, the second rotating body disposed in contact with the outer surface of the first rotating body, the pressing member that is disposed within the second rotating body and that presses the second rotating body toward the first rotating body from the inner surface of the second rotating body, the sheet member disposed between the inner surface of the second rotating body and the pressing member, and the lubricant interposed between the second rotating body and the sheet member. In the sheet member, the slide layer thereof that constitutes the slide surface on which the second rotating body slides contains cross-linked PTFE resin. The lubricant contains amino-modified silicone oil and terminal-modified PFPE.

The fixing device according to this exemplary embodiment may further include a heating source that heats at least one of the first rotating body and the second rotating body.

An inner surface (i.e., inner peripheral surface) of a heating belt or a pressure belt as an example of the second rotating body may have a surface roughness Ra ranging between 0.1 μm and 2.0 μm, and more desirably between 0.3 μm and 1.5 μm. With the aforementioned ranges, the slide resistance between the sheet member and the heating belt or the pressure belt as an example of the second rotating body may be reduced. Moreover, the lubricant may be readily retained between the two components, thereby improving the abrasion resistance of the sheet member.

The surface roughness Ra is measured by using a surface-roughness measuring device “SURFCOM 1400A” (manufactured by Tokyo Seimitsu Co., Ltd.) in compliance with JIS B0601-1994 in a condition in which an evaluation length Ln is 4 mm, a reference length L is 0.8 mm, and a cutoff value is 0.8 mm.

Although there are various kinds of configurations for the fixing device according to this exemplary embodiment, the following two exemplary embodiments will be described in detail.

As a first exemplary embodiment, a fixing device including a heating roller having a heating source and a pressure belt pressed by a pressing pad will be described.

As a second exemplary embodiment, a fixing device including a heating belt, which has a heating source and is pressed by a pressing pad, and a pressure roller will be described.

### Fixing Device According to First Exemplary Embodiment

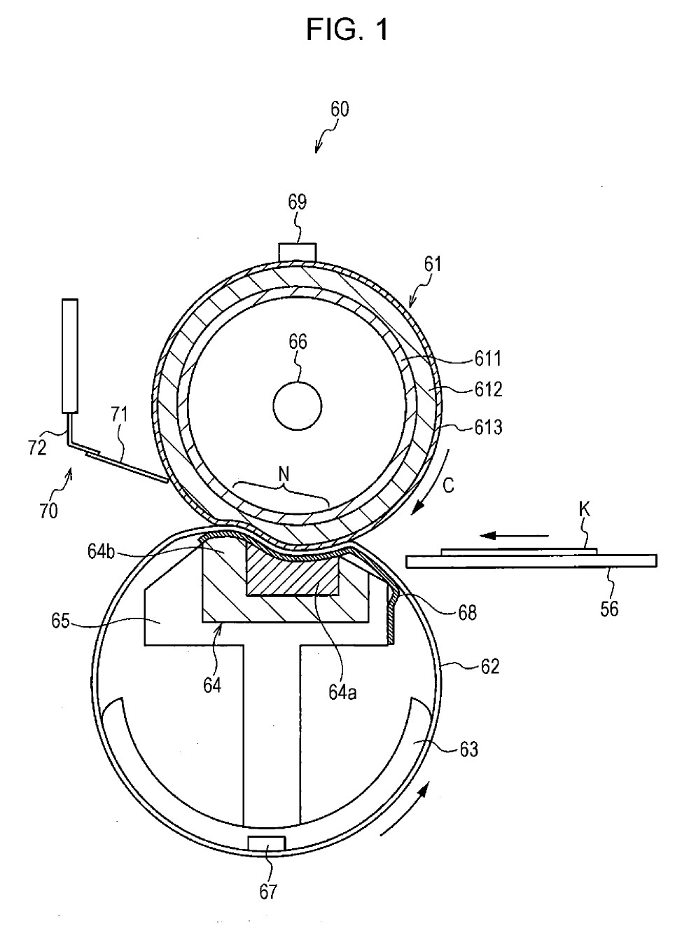

A fixing device 60 according to the first exemplary embodiment will now be described with reference to FIG. 1.

FIG. 1 schematically illustrates the configuration of the fixing device 60 according to the first exemplary embodiment.

The fixing device 60 includes a heating roller 61 (as an example of the first rotating body), a pressure belt 62 (as an example of the second rotating body), a pressing pad 64 (as an example of the pressing member), a sheet member 68 (as an example of the sheet member), and a halogen lamp 66 (as an example of the heating source).

The outer peripheral surface of the heating roller 61 and the outer peripheral surface of the pressure belt 62 are in contact with and apply and receive pressure to and from each other. The pressure belt 62 may press against the heating roller 61, or the heating roller 61 may press against the pressure belt 62. A nip region N is formed where the heating roller 61 and the pressure belt 62 are in contact with each other.

The heating roller 61 includes the halogen lamp 66 (as an example of the heating source) therein. The heating source is not limited to a halogen lamp and may alternatively be other heating components that generate heat.

A temperature sensor 69 is disposed in contact with the outer peripheral surface of the heating roller 61. Based on a temperature value measured by the temperature sensor 69, the halogen lamp 66 is on-off controlled so that the surface temperature of the heating roller 61 is maintained at a preset temperature (e.g., 150° C. to 180° C.)

The heating roller 61 is formed by, for example, laminating a heat-resisting elastic layer 612 and a release layer 613 in that order around a metallic core (cylindrical cored bar) 611.

The pressure belt 62 is disposed in contact with the outer peripheral surface of the heating roller 61.

The pressure belt 62 is rotatably supported by the pressing pad 64 and a belt guide 63 that are disposed within the pressure belt 62.

The pressing pad 64 is disposed within the pressure belt 62 and applies and receives pressure to and from the heating roller 61 via the pressure belt 62.

The pressing pad 64 includes a front nipping member 64a at the entrance side of the nip region N and a detachment nipping member 64b at the exit side of the nip region N.

The front nipping member 64a has a recessed shape that conforms to the outer peripheral shape of the heating roller 61 and ensures the length of the nip region N (i.e., the distance thereof in the sliding direction).

The detachment nipping member 64b has a shape that protrudes toward the outer peripheral surface of the heating roller 61 and causes the heating roller 61 to be locally distorted in an exit area of the nip region N so as to facilitate detachment of a recording medium from the heating roller 61 after a fixing process.

The sheet member 68 is sheet-shaped and is disposed between the pressure belt 62 and the pressing pad 64 such that a slide surface of the sheet member 68 is in contact with the inner peripheral surface of the pressure belt 62.

The sheet member 68 retains the lubricant between the slide surface and the inner peripheral surface of the pressure belt 62.

In order to reduce the slide resistance between the inner peripheral surface of the pressure belt 62 and the pressing pad 64, the sheet member 68 is disposed so as to cover the front nipping member 64a and the detachment nipping member 64b.

A support member 65 supports the pressing pad 64 and the sheet member 68. The support member 65 is composed of for example, metal.

The belt guide 63 is attached to the support member 65. The pressure belt 62 rotates along the belt guide 63.

A lubricant feeder 67 as a unit that feeds the lubricant to the inner peripheral surface of the pressure belt 62 may be attached to the belt guide 63. The lubricant fed to the inner peripheral surface of the pressure belt 62 is transported and fed to the slide surface of the sheet member 68.

A detachment member 70 as a recording-medium detachment assisting unit is provided downstream of the nip region N. The detachment member 70 includes a detachment claw 71 and a supporter 72 that supports the detachment claw 71. The detachment claw 71 is disposed near the heating roller 61 and extends in a direction (i.e., counter direction) opposed to the rotational direction of the heating roller 61.

The heating roller 61 is rotated in a direction indicated by an arrow C by a driving motor (not shown), and the pressure belt 62 driven by this rotation rotates in a direction opposite to the rotational direction of the heating roller 61.

A sheet K (i.e., recording medium) having an unfixed toner image thereon is transported to the nip region N by being guided by a fixation entrance guide 56. As the sheet K travels through the nip region N, the toner image on the sheet K is fixed thereon by pressure and heat applied to the nip region N.

### Fixing Device According to Second Exemplary Embodiment

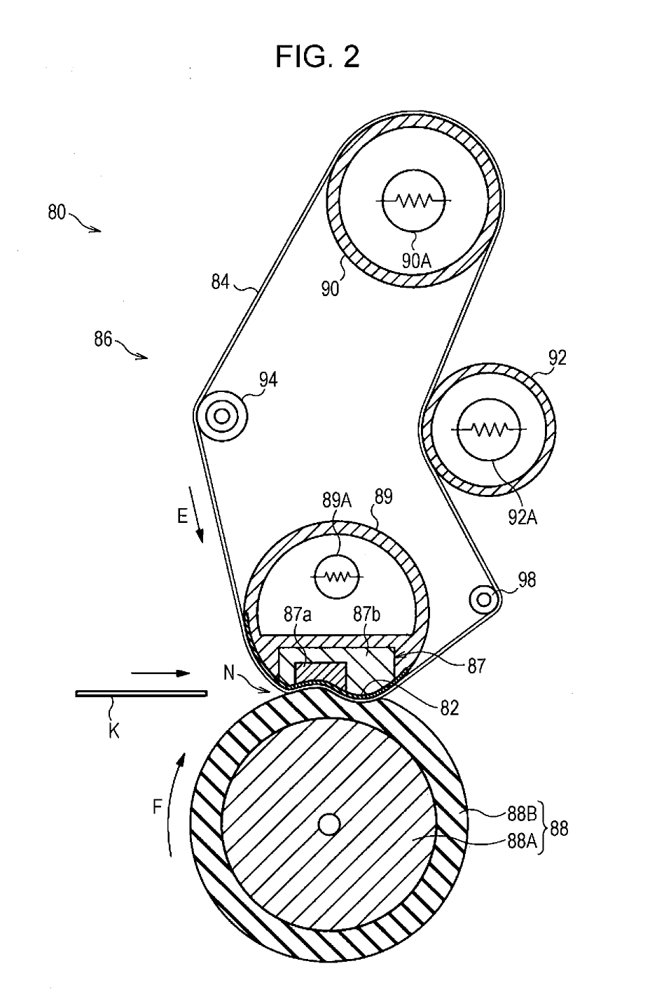

A fixing device 80 according to the second exemplary embodiment will now be described with reference to FIG. 2.

FIG. 2 schematically illustrates the fixing device 80 according to the second exemplary embodiment.

The fixing device 80 includes a pressure roller 88 (as an example of the first rotating body) and a fixing belt module 86.

The fixing belt module 86 includes a heating belt 84 (as an example of the second rotating body), a pressing pad 87 (as an example of the pressing member), a sheet member 82 (as an example of the sheet member according to this exemplary embodiment), and a halogen heater 89A (as an example of the heating source) disposed near the pressing pad 87.

The fixing belt module 86 further includes a support roller 90, a support roller 92, an orientation correcting roller 94, and a support roller 98.

The pressure roller 88 is pressed against the heating belt 84 (i.e., the fixing belt module 86) so that the nip region N is formed where the pressure roller 88 and the heating belt 84 (i.e., the fixing belt module 86) are in contact with each other.

The heating belt 84 is an endless belt rotatably supported by the pressing pad 87 and the support roller 90 that are disposed within the heating belt 84.

The pressing pad 87 has the heating belt 84 wound therearound and presses the heating belt 84 toward the pressure roller 88.

The pressing pad 87 includes a front nipping member 87a and a detachment nipping member 87b and is supported by a support member 89.

The front nipping member 87a has a recessed shape that conforms to the outer peripheral shape of the pressure roller 88. The front nipping member 87a is disposed at the entrance side of the nip region N and ensures the length of the nip region N (i.e., the distance thereof in the sliding direction).

The detachment nipping member 87b has a shape that protrudes toward the outer peripheral surface of the pressure roller 88. The detachment nipping member 87b is disposed at the exit side of the nip region N and causes the pressure roller 88 to be locally distorted in an exit area of the nip region N so as to facilitate detachment of a recording medium from the pressure roller 88 after a fixing process.

The pressing pad 87 includes the halogen heater 89A (as an example of the heating source) in the vicinity thereof (e.g., inside the support member 89) and heats the heating belt 84 from the inner peripheral surface thereof.

For example, a lubricant feeder (not shown) as a unit that feeds the lubricant to the inner peripheral surface of the heating belt 84 may be attached to the support member 89 at the upstream side of the front nipping member 87a. The lubricant fed to the inner peripheral surface of the heating belt 84 is transported and fed to the slide surface of the sheet member 82.

The sheet member 82 is sheet-shaped and is disposed between the heating belt 84 and the pressing pad 87 such that the slide surface of the sheet member 82 is in contact with the inner peripheral surface of the heating belt 84.

The sheet member 82 retains the lubricant between the slide surface and the inner peripheral surface of the heating belt 84.

The support roller 90 has the heating belt 84 wound therearound and supports the heating belt 84 at a position different from that of the pressing pad 87.

The support roller 90 includes a halogen heater 90A (as an example of the heating source) therein and heats the heating belt 84 from the inner peripheral surface thereof.

The support roller 90 is formed by, for example, forming a fluororesin release layer having a thickness of 20 μm around the outer peripheral surface of an aluminum cylindrical roller.

The support roller 92 is disposed in contact with the outer peripheral surface of the heating belt 84 between the pressing pad 87 and the support roller 90 and regulates a rotation path of the heating belt 84.

The support roller 92 includes a halogen heater 92A (as an example of the heating source) therein and heats the heating belt 84 from the outer peripheral surface thereof.

The support roller 92 is formed by, for example, forming a fluororesin release layer having a thickness of 20 μm around the outer peripheral surface of an aluminum cylindrical roller.

At least one of the halogen heater 89A, the halogen heater 90A, and the halogen heater 92A as examples of heating sources may be provided.

The orientation correcting roller. 94 is disposed in contact with the inner peripheral surface of the heating belt 84 between the support roller 90 and the pressing pad 87 and corrects the orientation of the heating belt 84 between the support roller 90 and the pressing pad 87.

An edge-position measuring mechanism (not shown) that measures the edge position of the heating belt 84 is disposed in the vicinity of the orientation correcting roller 94. The orientation correcting roller 94 is provided with an axially shifting mechanism (not shown) that shifts the abutment position of the heating belt 84 in the axial direction thereof in accordance with a measurement result of the edge-position measuring mechanism. These mechanisms correct the orientation of the heating belt 84.

The orientation correcting roller 94 is, for example, an aluminum cylindrical roller.

The support roller 98 is disposed in contact with the inner peripheral surface of the heating belt 84 between the pressing pad 87 and the support roller 92 and applies tension to the heating belt 84 from the inner peripheral surface of the heating belt 84 at the downstream side of the nip region N.

The support roller 98 is formed by, for example, forming a fluororesin release layer having a thickness of 20 μm around the outer peripheral surface of an aluminum cylindrical roller.

The pressure roller 88 is pressed against the heating belt 84 in an area where the heating belt 84 is wound around the pressing pad 87.

The pressure roller 88 is rotatable and is driven by the heating belt 84 as the heating belt 84 rotates in a direction indicated by an arrow E, thereby rotating in a direction indicated by an arrow F.

The pressure roller 88 is formed by, for example, laminating a silicone-rubber elastic layer 88B and a fluororesin detachment layer (not shown) having a thickness of 100 μm in that order around the outer peripheral surface of an aluminum cylindrical roller 88A.

For example, the support roller 90 and the support roller 92 are rotated by a driving motor (not shown). The heating belt 84 driven by this rotation rotates in the direction of the arrow E. The pressure roller 88 driven by the rotation of the heating belt 84 rotates in the direction of the arrow F.

A sheet K (i.e., recording medium) having an unfixed toner image thereon is transported to the nip region N of the fixing device 80. Then, as the sheet K travels through the nip region N, the toner image on the sheet K is fixed thereon by pressure and heat applied to the nip region N.

Image Forming Apparatus

An image forming apparatus according to an exemplary embodiment includes an image bearing body, a charging device that electrostatically charges the surface of the image bearing body, a latent-image forming device that forms a latent image on the electrostatically-charged surface of the image bearing body, a developing device that forms a toner image by developing the latent image by using toner, a transfer device that transfers the toner image onto a recording medium, and the fixing device according to one of the above exemplary embodiments, which fixes the toner image onto the recording medium.

An electrophotographic image forming apparatus will be described below as an example of the image forming apparatus according to this exemplary embodiment. The image forming apparatus according to this exemplary embodiment is not limited to an electrophotographic image forming apparatus and may be known image forming apparatuses other than the electrophotographic type (such as an inkjet recording apparatus).

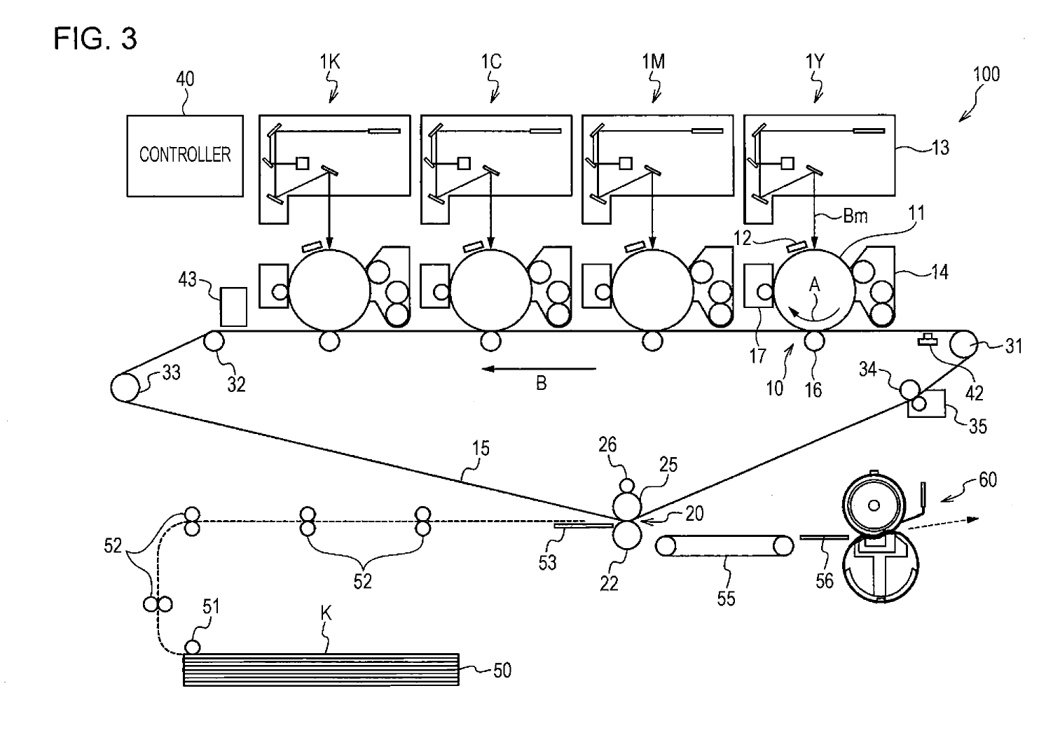

The image forming apparatus according to this exemplary embodiment will now be described with reference to FIG. 3.

FIG. 3 schematically illustrates the configuration of an image forming apparatus 100 according to this exemplary embodiment. The image forming apparatus 100 includes the fixing device 60 according to the first exemplary embodiment described above. The image forming apparatus 100 may alternatively include the fixing device 80 according to the second exemplary embodiment described above in place of the fixing device 60.

The image forming apparatus 100 is a so-called tandem-type intermediate-transfer image forming apparatus. The image forming apparatus 100 includes image forming units 1Y, 1M, 1C, and 1K that form toner images of respective colors by electrophotography, a first transfer section 10 that sequentially transfers (first-transfers) the toner images onto an intermediate transfer belt 15, a second transfer section 20 that collectively transfers (second-transfers) the superposed toner images transferred on the intermediate transfer belt 15 onto a sheet K as a recording medium, the fixing device 60 that fixes the second-transferred images onto the sheet K, and a controller 40 that controls the operation of each device (i.e., each section).

The image forming units 1Y, 1M, 1C, and 1K are arranged substantially linearly from the upstream side of the intermediate transfer belt 15 in the following order; the image forming unit 1Y for a yellow image, the image forming unit 1M for a magenta image, the image forming unit 1C for a cyan image, and the image forming unit 1K for a black image.

The image forming units 1Y, 1M, 1C, and 1K each include a photoconductor 11 (as an example of the image bearing body). The photoconductor 11 rotates in a direction indicated by an arrow A.

The photoconductor 11 is surrounded by a charging unit 12 (as an example of the charging device), a laser exposure unit 13 (as an example of the latent-image forming device), a developing unit 14 (as an example of the developing device), a first transfer roller 16, and a photoconductor cleaner 17 in that order in the rotational direction of the photoconductor 11.

The charging unit 12 electrostatically charges the surface of the photoconductor 11.

The laser exposure unit 13 forms an electrostatic latent image on the photoconductor 11 by emitting an exposure beam Bm thereto.

The developing unit 14 accommodates therein a toner of the corresponding color and develops the electrostatic latent image on the photoconductor 11 into a visible image by using the toner.

The first transfer roller 16 transfers the toner image formed on the photoconductor 11 onto the intermediate transfer belt 15 at the first transfer section 10.

The photoconductor cleaner 17 removes residual toner from the photoconductor 11.

The intermediate transfer belt 15 is composed of a material obtained by adding an antistatic agent, such as carbon black, to polyimide or polyamide resin. The intermediate transfer belt 15 has a volume resistivity ranging between, for example, 10⁶ Ωcm and 10¹⁴ Ωcm, and a thickness of, for example, 0.1 mm.

The intermediate transfer belt 15 is supported by a driving roller 31, a support roller 32, a tension applying roller 33, a back-surface roller 25, and a cleaning back-surface roller 34, and is rotationally driven (rotated) in a direction indicated by an arrow B by rotation of the driving roller 31.

The driving roller 31 is driven by a motor (not shown) having excellent constant-speed properties so as to rotate the intermediate transfer belt 15.

The support roller 32 supports the intermediate transfer belt 15, which extends substantially linearly in the arranged direction of the four photoconductors 11, together with the driving roller 31.

The tension applying roller 33 applies fixed tension to the intermediate transfer belt 15 and also functions as a correcting roller that suppresses meandering of the intermediate transfer belt 15.

The back-surface roller 25 is provided in the second transfer section 20. The cleaning back-surface roller 34 is provided in a cleaning section that scrapes off residual toner from the intermediate transfer belt 15.

The first transfer rollers 16 are disposed in pressure contact with the photoconductors 11 with the intermediate transfer belt 15 interposed therebetween, thereby forming the first transfer section 10.

The first transfer rollers 16 receive a voltage (i.e., first transfer bias) with a reversed polarity relative to the charge polarity of the toners (which is a negative polarity; the same applies hereinafter). Thus, the toner images on the photoconductors 11 are sequentially electrostatically attracted toward the intermediate transfer belt 15, whereby superposed toner images are formed on the intermediate transfer belt 15.

Each first transfer roller 16 is a cylindrical roller constituted of a shaft (i.e., a columnar rod composed of metal, such as iron or steel use stainless (SUS)) and an elastic layer (e.g., a sponge layer containing a blend of rubber and an electrically conductive agent, such as carbon black) fixedly attached around the shaft. Each first transfer roller 16 has a volume resistivity ranging between, for example, 10^{7.5} Ωcm and 10^{8.5} Ωcm.

A second transfer roller 22 is disposed in pressure contact with the back-surface roller 25 with the intermediate transfer belt 15 interposed therebetween, thereby forming the second transfer section 20.

By generating a second transfer bias between the second transfer roller 22 and the back-surface roller 25, the second transfer roller 22 second-transfers the toner images onto the sheet K (i.e., recording medium) transported to the second transfer section 20.

The second transfer roller 22 is a cylindrical roller constituted of a shaft (i.e., a columnar rod composed of metal, such as iron or SUS) and an elastic layer (e.g., a sponge layer containing a blend of rubber and an electrically conductive agent, such as carbon black) fixedly attached around the shaft. The second transfer roller 22 has a volume resistivity ranging between, for example, 10^{7.5} Ωcm and 10^{8.5} Ωcm.

The back-surface roller 25 is disposed at the back surface of the intermediate transfer belt 15 and serves as a counter-electrode for the second transfer roller 22 so that a transfer electric field is generated between the back-surface roller 25 and the second transfer roller 22.

The back-surface roller 25 is formed by, for example, coating a rubber base material with a tube containing a blend of rubber and carbon distributed therein. The back-surface roller 25 has a surface resistivity ranging between, for example, 10⁷ Ω/sq. and 10¹⁰ Ω/sq. and a hardness of, for example, 70° (measured using “ASKER C” manufactured by Kobunshi Keiki Co., Ltd.; the same applies hereinafter).

The back-surface roller 25 is disposed in contact with a power feeding roller 26 composed of metal. The power feeding roller 26 applies a voltage (i.e., second transfer bias) with the same polarity as the charge polarity of the toners (which is a negative polarity) so as to generate a transfer electric field between the second transfer roller 22 and the back-surface roller 25.

An intermediate-transfer-belt cleaner 35 for the intermediate transfer belt 15 is provided downstream of the second transfer section 20 in a movable manner toward and away from the intermediate transfer belt 15. The intermediate-transfer-belt cleaner 35 removes residual toner and paper particles from the intermediate transfer belt 15 after the second transfer process.

A reference sensor (i.e., home-position sensor) 42 is disposed upstream of the image forming unit 1Y. The reference sensor 42 generates a reference signal to be used as a reference for setting an image forming timing in the image forming units. The reference sensor 42 generates the reference signal by detecting a mark provided at the back surface of the intermediate transfer belt 15. Based on a command from the controller 40 having recognized this reference signal, the image forming units 1Y, 1M, 1C, and 1K commence an image forming process.

An image density sensor 43 for performing image quality adjustment is disposed downstream of the image forming unit 1K.

As a transport unit for transporting a sheet K, the image forming apparatus 100 includes a sheet accommodation section 50, a feed roller 51, a transport roller 52, a transport guide 53, a transport belt 55, and a fixation entrance guide 56.

The sheet accommodation section 50 accommodates sheets K that have not undergone an image forming process yet.

The feed roller 51 feeds each sheet K accommodated in the sheet accommodation section 50.

The transport roller 52 transports the sheet K fed by the feed roller 51.

The transport guide 53 delivers the sheet K transported by the transport roller 52 to the second transfer section 20.

The transport belt 55 transports the sheet K having an image transferred thereto by the second transfer section 20 to the fixing device 60.

The fixation entrance guide 56 guides the sheet K to the fixing device 60.

Next, an image forming method by the image forming apparatus 100 will be described.

In the image forming apparatus 100, image data output from an image reading device (not shown), a computer (not shown), or the like is image-processed by an image processing device (not shown), and an image forming process is performed by the image forming units 1Y, 1M, 1C, and 1K.

The image processing device performs image processing, such as shading correction, misregistration correction, brightness/color-space conversion, gamma correction, margin deletion, color editing, displacement editing, on input reflectance data. The image-processed image data is converted to colorant gradation data for the Y, M, C, and K colors and is output to the laser exposure units 13.

The laser exposure units 13 radiate exposure beams Bm onto the photoconductors 11 in the image forming units 1Y, 1M, 1C, and 1K in accordance with the input colorant gradation data.

The surfaces of the photoconductors 11 in the image forming units 1Y, 1M, 1C, and 1K are electrostatically charged by the charging units 12 and subsequently undergo a scan exposure process by the laser exposure units 13, whereby electrostatic latent images are formed on the photoconductors 11. The electrostatic latent images formed on the photoconductors 11 are developed into toner images of the respective colors by the image forming units.

The toner images formed on the photoconductors 11 in the image forming units 1Y, 1M, 1C, and 1K are transferred onto the intermediate transfer belt 15 at the first transfer section 10 where the photoconductors 11 and the intermediate transfer belt 15 come into contact with each other. In the first transfer section 10, the first transfer rollers 16 apply a voltage (i.e., first transfer bias) with a reversed polarity relative to the charge polarity of the toners (which is a negative polarity) to the intermediate transfer belt 15 so that the toner images are sequentially superposed and transferred onto the intermediate transfer belt 15.

Due to the movement of the intermediate transfer belt 15, the toner images first-transferred on the intermediate transfer belt 15 are transported to the second transfer section 20.

In accordance with a timing at which the toner images reach the second transfer section 20, a sheet K accommodated in the sheet accommodation section 50 is fed to the second transfer section 20 by being transported by the feed roller 51, the transport roller 52, and the transport guide 53, so as to become nipped between the intermediate transfer belt 15 and the second transfer roller 22.

Then, in the second transfer section 20 where a transfer electric field is generated, the toner images on the intermediate transfer belt 15 are electrostatically transferred (second-transferred) onto the sheet K.

The sheet K having the toner images electrostatically transferred thereon is detached from the intermediate transfer belt 15 by the second transfer roller 22 and is transported to the fixing device 60 by the transport belt 55.

The sheet K transported to the fixing device 60 is heated and pressed by the fixing device 60 so that the unfixed toner images become fixed onto the sheet K.

As a result of the above-described steps, an image is formed on the recording medium by the image forming apparatus 100.

### EXAMPLES

Although the above exemplary embodiments of the present invention will be described in detail with reference to examples, the exemplary embodiments are not to be limited to the examples to be described below so long as they do not depart from the spirit of the invention.

### First Example

### Fabrication of Sheet Member

A resin composition constituted of non-cross-linked PTFE resin and cross-linked PTFE resin (XF-1B manufactured by Hitachi Cable, Ltd. and in which the content percentage of cross-linked PTFE resin is 50% by mass) is set in a mold and is compression-molded. Then, the resin composition is heated and fired at a temperature higher than or equal to the melting point of the resin, whereby a molded body is obtained. This molded body is skived by using a metallic cutter, whereby a sheet material with a thickness of 20 μm is obtained.

Subsequently, a fluororesin dispersion (Neoflon (registered trademark) FEP ND-1 manufactured by Daikin Industries, Ltd. and having a melting point of 260° C.) is applied over glass cloth (with a thickness of 90 μm) and is melted and impregnated therein at 290° C., whereby a glass-cloth substrate is obtained.

Then, the sheet material and the glass-cloth substrate are laminated in the following order: sheet material, glass-cloth substrate, and sheet material. The laminate is heated at 300° C. and pressure-bonded with 60 kg/cm². As a result, a sheet member (1) (with a thickness of 140 μm) is obtained.

Fabrication of Lubricant

Amino-modified silicone oil (KF-8009A manufactured by Shin-Etsu Chemical Co., Ltd. and having a kinetic viscosity (at 25° C.) of 300 mm²/s) and one-terminal-phosphate-modified PFPE (phosphate-modified perfluoropolyether oil P manufactured by Daikin Industries, Ltd.) are mixed together such that the content percentage of one-terminal-phosphate-modified PFPE is 0.5% by mass, whereby a lubricant (1) is obtained.

Fabrication of Fixing Device and Image Forming Apparatus

An image forming apparatus (color printer C2220 manufactured by Fuji Xerox Co., Ltd.) equipped with a fixing device having a configuration similar to that shown in FIG. 1 is prepared. The sheet member (1) is attached to the fixing device, and the lubricant (1) is interposed between the pressure belt and the sheet member (1).

In this case, the pressure belt is formed by forming a release layer (with a thickness of 30 μm) composed of a tetrafluoroethylene-perfluoroalkylvinyl ether copolymer over the outer peripheral surface of a base member (with a perimeter of 94 mm, a wall thickness of 75 μm, and a length of 320 mm) composed of thermosetting polyimide.

Evaluation

An image forming process for an evaluation is performed under an environment of 22° C. and 55 RH % with the surface temperature of the heating roller being set at 175° C. and the processing speed being set at 194 mm/s.

The drive torque when the image forming apparatus is activated for the first time is measured by attaching a torque meter (manufactured by Fuji Xerox Co., Ltd.) to a fixing roller in the fixing device.

The operation of the image forming apparatus is stopped when 200,000 A4-size sheets have passed therethrough. Subsequently, the drive torque when the apparatus is reactivated is measured in a manner similar to the above.

Then, the drive torque values are evaluated in accordance with evaluation criteria below. The results are shown in Table 1.

The evaluation criteria for the drive torque are as follows.

A: 0.8 Nm or lower

B: Higher than 0.8 Nm but lower than or equal to 1.4 Nm

C: Higher than 1.4 Nm

When the drive torque exceeds 1.4 Nm, noise may be generated, a sheet serving as a recording medium may become wrinkled, or an image may become distorted.

### Second Example

A sheet member (2) (with a thickness of 140 μm) is fabricated in a manner similar to the first example except that the resin composition used for fabricating the sheet member in the first example is changed to XF-1A manufactured by Hitachi Cable, Ltd. (which is composed of non-cross-linked PTFE and cross-linked PTFE and in which the content percentage of cross-linked PTFE is 10% by mass).

A fixing device and an image forming apparatus are fabricated in a manner similar to the first example except that the sheet member (1) is changed to the sheet member (2), and an evaluation is performed. The results are shown in Table 1.

### Third Example

A lubricant (3) is fabricated in a manner similar to the first example except that the one-terminal-phosphate-modified PFPE used in the first example is changed to one-terminal-alcohol-modified PFPE (alcohol-modified perfluoropolyether oil SA manufactured by Daikin Industries, Ltd.).

A fixing device and an image forming apparatus are fabricated in a manner similar to the first example except that the lubricant (1) is changed to the lubricant (3), and an evaluation is performed. The results are shown in Table 1.

### Fourth Example

A lubricant (4) is fabricated in a manner similar to the first example except that the content percentage of one-terminal-phosphate-modified PFPE used in the first example is changed to 0.06% by mass.

A fixing device and an image forming apparatus are fabricated in a manner similar to the first example except that the lubricant (1) is changed to the lubricant (4), and an evaluation is performed. The results are shown in Table 1.

### Fifth Example

A lubricant (5) is fabricated in a manner similar to the first example except that the content percentage of one-terminal-phosphate-modified PFPE used in the first example is changed to 4.9% by mass.

A fixing device and an image forming apparatus are fabricated in a manner similar to the first example except that the lubricant (1) is changed to the lubricant (5), and an evaluation is performed. The results are shown in Table 1.

### First Comparative Example

A sheet member (C1) (with a thickness of 140 μm) is fabricated in a manner similar to the first example except that the resin composition used for fabricating the sheet member in the first example is changed to modified PTFE resin (new Polyflon (registered trademark) M-111 manufactured by Daikin Industries, Ltd.).

A fixing device and an image forming apparatus are fabricated in a manner similar to the first example except that the sheet member (1) is changed to the sheet member (C1), and an evaluation is performed. The results are shown in Table 1.

### Second Comparative Example

A sheet member (C2) (with a thickness of 140 μm) is fabricated in a manner similar to the first example except that the resin composition used for fabricating the sheet member in the first example is changed to PTFE resin (Teflon (registered trademark) molding powder 7-J manufactured by Du Pont-Mitsui Fluorochemicals Co., Ltd.).

A fixing device and an image forming apparatus are fabricated in a manner similar to the first example except that the sheet member (1) is changed to the sheet member (C2), and an evaluation is performed. The results are shown in Table 1.

### Third Comparative Example

A lubricant (C3) is fabricated in a manner similar to the first example except that the amino-modified silicone oil is changed to dimethyl silicone oil (KF-965 manufactured by Shin-Etsu Chemical Co., Ltd. and having a kinetic viscosity (at 25° C.) of 300 mm²/s).

A fixing device and an image forming apparatus are fabricated in a manner similar to the first example except that the lubricant (1) is changed to the lubricant (C3), and an evaluation is performed. The results are shown in Table 1.

### Fourth Comparative Example

A lubricant (C4) is fabricated in a manner similar to the first example except that the amino-modified silicone oil is changed to methylphenyl silicone oil (KF-54 manufactured by Shin-Etsu Chemical Co., Ltd. and having a kinetic viscosity (at 25° C.) of 600 mm²/s).

A fixing device and an image forming apparatus are fabricated in a manner similar to the first example except that the lubricant (1) is changed to the lubricant (C4), and an evaluation is performed. The results are shown in Table 1.

### Fifth Comparative Example

A lubricant (C5) is fabricated in a manner similar to the first example except that the one-terminal-phosphate-modified PFPE in the first example is not used.

A fixing device and an image forming apparatus are fabricated in a manner similar to the first example except that the lubricant (1) is changed to the lubricant (C5), and an evaluation is performed. The results are shown in Table 1.

TABLE 1

| | | | COMPONENTS OF LUBRICANT | | | | | | |
|---|---|---|---|---|---|---|---|---|---|
| | SLIDE LAYER OF | | | | CONTENT | DRIVE TORQUE | | | |
| | SHEET MEMBER | | | | PERCENTAGE | INITIAL STAGE | | AFTER 200,000 | |
| | | CONTENT | | | OF | OF OPERATION | | SHEETS | |
| | | PERCENTAGE | | TERMINAL- | TERMINAL- | MEASURE- | | MEASURE- | |
| | TYPE OF | OF CROSS- | | MODIFIED | MODIFIED | MENT | EVALU- | MENT | EVALU- |
| | RESIN | LINKED PTFE | OIL | PFPE | PFPE | VALUE | ATION | VALUE | ATION |
| FIRST | CROSS- | 50% BY MASS | AMINO- | ONE- | 0.5% BY | 0.4 Nm | A | 0.5 Nm | A |
| EXAMPLE | LINKED | | MODIFIED | TERMINAL- | MASS | | | | |
| | PTFE | | SILICONE | PHOSPHATE- | | | | | |
| | AND PTFE | | OIL | MODIFIED | | | | | |
| | | | | PFPE | | | | | |
| SECOND | CROSS- | 10% BY MASS | AMINO- | ONE- | 0.5% BY | 0.4 Nm | A | 0.5 Nm | A |
| EXAMPLE | LINKED | | MODIFIED | TERMINAL- | MASS | | | | |
| | PTFE | | SILICONE | PHOSPHATE- | | | | | |
| | AND PTFE | | OIL | MODIFIED | | | | | |
| | | | | PFPE | | | | | |
| THIRD | CROSS- | 50% BY MASS | AMINO- | ONE- | 0.5% BY | 0.5 Nm | A | 0.95 Nm | B |
| EXAMPLE | LINKED | | MODIFIED | TERMINAL- | MASS | | | | |
| | PTFE | | SILICONE | ALCOHOL- | | | | | |
| | AND PTFE | | OIL | MODIFIED | | | | | |
| | | | | PFPE | | | | | |
| FOURTH | CROSS- | 50% BY MASS | AMINO- | ONE- | 0.06% BY | 0.5 Nm | A | 1.0 Nm | B |
| EXAMPLE | LINKED | | MODIFIED | TERMINAL- | MASS | | | | |
| | PTFE | | SILICONE | PHOSPHATE- | | | | | |
| | AND PTFE | | OIL | MODIFIED | | | | | |
| | | | | PFPE | | | | | |
| FIFTH | CROSS- | 50% BY MASS | AMINO- | ONE- | 4.9% BY | 0.4 Nm | A | 0.5 Nm | A |
| EXAMPLE | LINKED | | MODIFIED | TERMINAL- | MASS | | | | |
| | PTFE | | SILICONE | PHOSPHATE- | | | | | |
| | AND PTFE | | OIL | MODIFIED | | | | | |
| | | | | PFPE | | | | | |
| FIRST | MODIFIED | 0% BY MASS | AMINO- | ONE- | 0.5% BY | 1.5 Nm | C | 2.2 Nm | C |
| COMPARATIVE | PTFE | | MODIFIED | TERMINAL- | MASS | | | | |
| EXAMPLE | | | SILICONE | PHOSPHATE- | | | | | |
| | | | OIL | MODIFIED | | | | | |
| | | | | PFPE | | | | | |
| SECOND | PTFE | 0% BY MASS | AMINO- | ONE- | 0.5% BY | 1.6 Nm | C | 3.3 Nm | C |
| COMPARATIVE | | | MODIFIED | TERMINAL- | MASS | | | | |
| EXAMPLE | | | SILICONE | PHOSPHATE- | | | | | |
| | | | OIL | MODIFIED | | | | | |
| | | | | PFPE | | | | | |
| THIRD | CROSS- | 50% BY MASS | DIMETHYL | ONE- | 0.5% BY | 1.0 Nm | B | 2.1 Nm | C |
| COMPARATIVE | LINKED | | SILICONE | TERMINAL- | MASS | | | | |
| EXAMPLE | PTFE | | OIL | PHOSPHATE- | | | | | |
| | AND PTFE | | | MODIFIED | | | | | |
| | | | | PFPE | | | | | |
| FOURTH | CROSS- | 50% BY MASS | METHYL- | ONE- | 0.5% BY | 1.0 Nm | B | 2.2 Nm | C |
| COMPARATIVE | LINKED | | PHENYL | TERMINAL- | MASS | | | | |
| EXAMPLE | PTFE | | SILICONE | PHOSPHATE- | | | | | |
| | AND PTFE | | OIL | MODIFIED | | | | | |
| | | | | PFPE | | | | | |
| FIFTH | CROSS- | 50% BY MASS | AMINO- | — | 0% BY | 0.8 Nm | A | 5.1 Nm | C |
| COMPARATIVE | LINKED | | MODIFIED | | MASS | | | | |
| EXAMPLE | PTFE | | SILICONE | | | | | | |
| | AND PTFE | | OIL | | | | | | |

After performing an image forming process on 200,000 A4-size sheets, the drive-torque evaluation results indicate C for the first to fifth comparative examples, whereas the evaluation results indicate B or A for the first to fourth examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image fixing device comprising:
a first rotating body;
a second rotating body disposed in contact with an outer surface of the first rotating body;
a pressing member that is disposed within the second rotating body and that presses the second rotating body toward the first rotating body from an inner surface of the second rotating body;
a sheet member that is disposed between the second rotating body and the pressing member and that has a slide layer containing cross-linked polytetrafluoroethylene resin; and
a lubricant that is interposed between the second rotating body and the sheet member and that contains amino-modified silicone oil and terminal-modified perfluoropolyether.

2. The image fixing device according to claim 1, wherein the terminal-modified perfluoropolyether is a perfluoropolyether derivative having a phosphate group, a hydroxy group, or a carboxyl group at a terminal thereof.

3. The image fixing device according to claim 1, wherein the lubricant contains the terminal-modified perfluoropolyether in a range between 0.05 percent by mass and 5 percent by mass.

4. An image forming apparatus comprising:
an image bearing body;
a charging device that electrostatically charges a surface of the image bearing body;
a latent-image forming device that forms a latent image on the electrostatically-charged surface of the image bearing body;
a developing device that forms a toner image by developing the latent image by using toner;
a transfer device that transfers the toner image onto a recording medium; and
the image fixing device according to claim 1 that fixes the toner image onto the recording medium.
